(19) United States
(12) Patent Application Publication
(10) Pub. No.: US 2009/0113953 A1
(43) Pub. Date: May 7, 2009

(54) DEVICE FOR CONTROLLING A CONDITION OF AN EXIT DEVICE ON A DOOR

(76) Inventor: Steven R. Kem, Cornelius, OR (US)

Correspondence Address: GANZ LAW, P.C., P O BOX 2200, HILLSBORO, OR, 97123, US

(21) Appl. No.: 12/113,697

(22) Filed: May 1, 2008

Related U.S. Application Data
(60) Provisional application No. 60/915,405, filed on May 1, 2007.

(51) Int. Cl. E05B 65/06

(52) U.S. Cl. 70/91

(57) ABSTRACT

A lock-out device for an exit device door operator mechanism, the lock-out device being configured to interact with the operator mechanism, which would normally require a key to change the condition of the operator mechanism between a locked and unlocked condition, thereby allowing someone on the inside of the door to manually lock the door against entry from the exterior without using the key for the locking mechanism.

### RELATED APPLICATIONS

This application claims the benefit of and priority to U.S. Provisional Application Ser. No. 60/915,405, filed May 1, 2007, the contents of which is hereby incorporated by reference as if recited in full herein for all purposes.

### BACKGROUND

The inventive subject matter described herein relates to devices for manually controlling access from a door or other such entry port.

In many facilities, such as schools and workplaces, there are doors equipped with exit devices that are mounted on the inside face of a door and allow the door to be opened when a body pushes or presses against the device, free of hand contact. In such facilities, the doors are typically unlocked during hours of use and locked after hours. Typically a custodian of the facility walks door-to-door manually locking or unlocking each door with a key. Unfortunately the requirement of these systems is that if a security situation (e.g. a gunman) arises on a campus during hours of use, when doors are unlocked, the operator may not be able to go door-to-door as quickly as the security situation dictates. Therefore there is a need for devices to allow occupants of a particular space to immediately respond to a security situation by manually locking doors by themselves without needing to wait for anyone else to come along with the key normally needed to lock down the doors.

### SUMMARY

The inventive subject matter disclosed herein overcomes the problem with existing door operator mechanisms by providing a lock-out device that overrides a normal condition of the exit device mechanism, i.e., the door locking condition of the exit device mechanism. The lock-out device is configured to interact with the mechanism, which would typically require a key for a lock-down, and allows someone on the inside of the doorway to lock the door against entry from the exterior side, without the normal key for locking the mechanism.

According to one possible embodiment, the lock-out device interacts with an exit device door operator mechanism, the operator mechanism normally requiring a key to change the condition of the operator mechanism between a locked and unlocked condition. The lock-out device may have a piece of hardware configured to interact with the exit device door operator mechanism, thereby allowing someone on the inside of the door to manually lock the door against entry from the exterior without using the key for the locking mechanism. In the foregoing embodiment, the lock-out device may further have a receiver for mounting on a door and for receiving a portion of the lock-out device, enabling the lock-out device to hold the operator mechanism in an unlocked condition. In one of the foregoing embodiments, the piece of hardware may be configured to maintain a bar handle, such as a hinging bar handle, in a depressed position, and removal of the lock-out device allows the bar handle to return to an outward position that causes a door strike to engage its recess, locking the door.

In another possible embodiment, the piece of hardware may engage and hold a push bar assembly in a compressed position, and removal of the lock-out device allows the push bar assembly to be uncompressed, causing a door strike to engage its recess, locking the door. In one of the foregoing embodiments, the lock-out device may have a substantially U-shape. In another possible embodiment, the piece of hardware is provided with a handle.

In another possible embodiment, a lock-out device for an exit device door operator mechanism may have a receiver for mounting on a door, and a piece of hardware configured to slideably interact with the operator mechanism and the receiver. The receiver may receive a portion of the piece of hardware enabling the lock-out device to hold the operator mechanism in an unlocked condition, and allowing the lock-out device to manually lock the door against entry from the exterior without using the key for the locking mechanism, by removing the piece of hardware from the operator mechanism. In the foregoing embodiment, the piece of hardware may be provided with a handle.

This and other embodiments are described in more detail in the following detailed descriptions and the figures.

The foregoing is not intended to be an exhaustive list of embodiments and features of the present inventive subject matter. Persons skilled in the art are capable of appreciating other embodiments and features from the following detailed description in conjunction with the drawings.

### BRIEF DESCRIPTION OF THE DRAWINGS

The following figures show embodiments according to the inventive subject matter, unless noted as showing prior art.

FIG. 1A shows a side cross-section view of a door lock-out device mounted on a push-bar exit device of a door.

FIG. 1B shows a perspective view of the door lock-out device and receiver of FIG. 1A.

FIG. 2A shows another possible embodiment of the inventive subject matter with a hinging-bar type exit device.

FIG. 2B shows a perspective view of the door lock out device and receiver of FIG. 2A.

FIG. 3A shows another possible embodiment of the inventive subject matter with a push-bar type exit device.

FIG. 3B shows a perspective view of the door lock out device and receiver of FIG. 3A.

### DETAILED DESCRIPTION

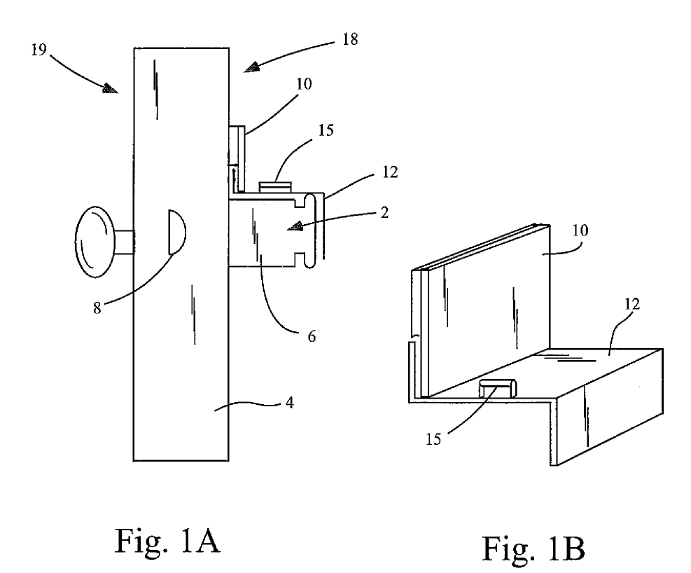

Representative embodiments according to the inventive subject matter are shown in FIGS. 1A-3B, wherein the same or generally similar features share common reference numerals.

The inventive subject matter is directed to devices for manually controlling access from a door or other such entry port. Examples of such commercially available exit devices are illustrated in the Figures below.

As used herein “key” refers to a traditional key or a tool, such as a hex wrench, that is used to change the condition of an exit device door operator mechanism.

FIG. 1A-B shows one possible embodiment of the subject matter, as it is used on a door 4 having an outside door surface 19, an inside door surface 18, and provided with an exit device 2 mounted on the inside surface 18 of door 4. The exit device 2 is the hardware that operates the door 4 from the inside. The exit device 2 includes an operator mechanism, such as an elongate push bar assembly 6 that when compressed slideably retracts the strike 8 of the door 4 from its recess in the door well. In this embodiment, a piece of hardware, such as a lock out device 12, is configured to interact with the operator mechanism. The lock-out device may be a single piece of hardware or a combination of pieces of hardware. As described below, the lock-out device may include a piece of hardware interacting with a receiver. In this type of lock-out device, shown in FIGS. 1A and 1B, a receiver 10 for lock-out device 12 is mounted on the door 4 just above the exit device 2. The lock-out device 12 is slid in place over a push bar assembly 6 in its compressed, open position, which holds the exit device 2 in the open position. In this system it is no longer necessary to use a key to set the door in a default, unlocked condition when occupants are in the room. Instead the exit device 2, when it has a lock-out device 12 on, is set in a default locked position, but the lock-out device 12 compresses the push bar assembly 6, preventing the retractable strike 8 of the door 4 from engaging its recess in the door well. To lock the door 4, a room occupant simply removes the lock-out device 12 from between the operator and receiver 10, causing the push bar 6 to uncompress and the door strike 8 to engage its recess, locking the door 4 from exterior entry.

The lock-out device may have a handle at a location that allows for convenient handling of the device. The handle may have any suitable shape, for example a rod mounted directly on a flat surface of the lock-out device. Removal of the lock-out device 12 from the push bar and receiver may be facilitated by handle 15.

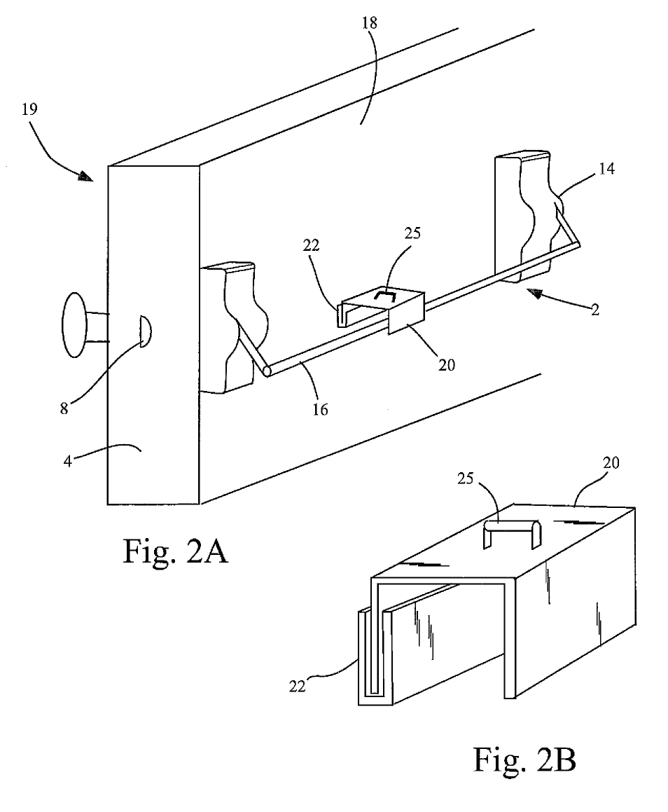

FIG. 2A-B shows another possible embodiment of the inventive subject matter. In this embodiment, the lock-out device 20 works with another common door exit device, such as a hinging-bar type exit device 14. In this embodiment the bar mechanism 14 works by pressing a bar component 16 hingingly towards the inside door surface 18. A C-shaped lock-out device 20 has one end that fits into a receiver 22 mounted on the door 4 and another end that fits over the bar 16, holding the bar in the pressed-in, open position. Removing the lock-out device 20 from the receiver 22 and bar handle 16 causes the bar handle 16 to release outwardly, and the door strike 8 to engage the recess in the door well, locking the door 4. Lock-out device 20 may have a handle 25 to facilitate removal from the bar handle 16 and receiver 22.

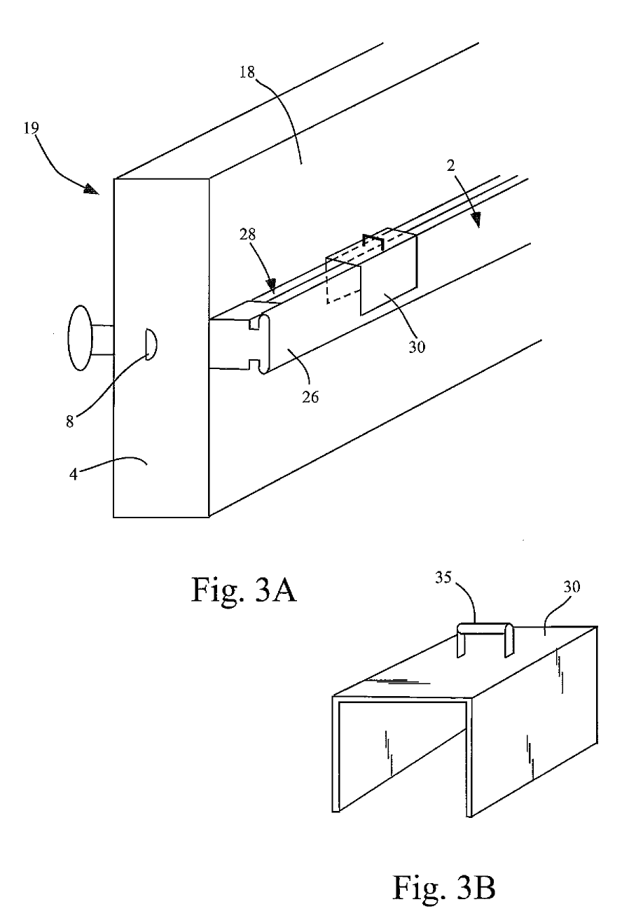

FIGS. 3A-B shows another possible embodiment of the inventive subject matter. The embodiment of FIGS. 3A-B is used with an exit device similar to that shown in FIGS. 1A-B. The device of FIGS. 1A-B is used for flush mounting on a door, and there is no gap between the door 4 and the elongated push bar assembly 6. Therefore, a receiver 10 for the lock-out device is required to be mounted on the door surface 18. In contrast, in FIGS. 3A-B the elongated bar assembly 26 is not mounted flush to the door 4 and a gap 28 is left between the bar assembly 26 and the door 4. This type of mounting is used on glass doors, for example. Because there is a gap 28 between the door 4 and push bar assembly 26, a lock-out device 30 for this arrangement does not need a receiver mounted on the door. Instead the lock-out device 30 is configured to fit over the push bar 26 in its compressed condition to retain that condition. Removal of the lock-out device 30 uncompresses the push-bar assembly 26, allowing for the door strike 8 to engage the recess of the door well, locking the door 4. Here also, a handle 35 may assist in removing lock-out device 30 from the push-bar assembly 26.

In the various embodiments, the lock-out device may be tethered to the door and/or the exit device so that it is not lost or improperly removed.

Persons skilled in the art will recognize that many modifications and variations are possible in the details, materials, and arrangements of the parts and actions which have been described and illustrated in order to explain the nature of this inventive concept and that such modifications and variations do not depart from the spirit and scope of the teachings and claims contained therein.

All patent and non-patent literature cited herein is hereby incorporated by references in its entirety for all purposes.

1. A lock-out device for an exit device door operator mechanism, the operator mechanism normally requiring a key to change the condition of the operator mechanism between a locked and unlocked condition, the lock-out device comprising:
a piece of hardware configured to interact with the exit device door operator mechanism, thereby allowing someone on the inside of the door to manually lock the door against entry from the exterior without using the key for the locking mechanism.

2. The lock-out device of claim 1 further comprising a receiver for mounting on a door and for receiving a portion of the lock-out device, enabling the lock-out device to hold the operator mechanism in an unlocked condition.

3. The lock-out device of claim 1 wherein the piece of hardware is configured to maintain a bar handle in a depressed position, and removal of the lock-out device allows the bar handle to return to an outward position that causes a door strike to engage its recess, locking the door.

4. The lock-out device of claim 3 wherein the bar handle is a hinging bar handle.

5. The lock-out device of claim 2 wherein the piece of hardware is configured to maintain a bar handle in a depressed position, and removal of the lock-out device allows the bar handle to return to an outward position that causes a door strike to engage its recess, locking the door.

6. The lock-out device of claim 5 wherein the bar handle is a hinging bar handle.

7. The lock-out device of claim 1 wherein the piece of hardware engages and holds a push bar assembly in a compressed position, and removal of the lock-out device allows the push bar assembly to be uncompressed, causing a door strike to engage its recess, locking the door.

8. The lock-out device of claim 2 wherein the piece of hardware engages and holds a push bar assembly in a compressed position, and removal of the lock-out device allows the push bar assembly to be uncompressed, causing a door strike to engage its recess, locking the door.

9. The lock-out device of claim 1 wherein the lock-out device has a substantially U-shape.

10. The lock-out device of claim 1, wherein the piece of hardware is provided with a handle.

11. A lock-out device for an exit device door operator mechanism, comprising:
a receiver for mounting on a door;
a piece of hardware configured to slideably interact with the operator mechanism and the receiver;
the receiver receiving a portion of the piece of hardware enabling the lock-out device to hold the operator mechanism in an unlocked condition, and
the lock-out device allowing for manually locking the door against entry from the exterior without using the key for the locking mechanism, by removing the piece of hardware from the operator mechanism.

12. The lock-out device of claim 1, wherein the piece of hardware is provided with a handle.

13. The lock-out device of claim 1 further comprising an exit door device, in a kit with the lock-out device.

14. The lock-out device of claim 3 further comprising an exit door device, in a kit with the lock-out device.

15. The lock-out device of claim 7 further comprising an exit door device, in a kit with the lock-out device.

16. The lock-out device of claim 11 further comprising an exit door device, in a kit with the lock-out device.

17. The lock-out device of claim 1, further comprising an exit device, the lock-out device being tethered to the exit device.

18. The lock-out device of claim 3, further comprising an exit device, the lock-out device being tethered to the exit device.

19. The lock-out device of claim 7, further comprising an exit device, the lock-out device being tethered to the exit device.

20. The lock-out device of claim 11, further comprising an exit device, the lock-out device being tethered to the exit device.
